(19) United States
(12) Patent Application Publication
(10) Pub. No.: US 2026/0080725 A1
(43) Pub. Date: Mar. 19, 2026

(54) Evaluation of Fault Codes

(71) Applicants: Jan Steinbach, Münster (DE); Cafer Ince, Ulm (DE)

(72) Inventors: Jan Steinbach, Münster (DE); Cafer Ince, Ulm (DE)

(73) Assignee: Schmitz Cargobull AG, Altenberge (DE)

(21) Appl. No.: 19/321,868

(22) Filed: Sep. 8, 2025

(30) Foreign Application Priority Data
Sep. 13, 2024 (EP) 24200360.6

(51) Int. Cl. G07C 5/08; G07C 5/00

(52) U.S. Cl. CPC G07C 5/0816; G07C 5/008; G07C 5/0808

(57) ABSTRACT

A method includes obtaining a plurality of fault codes for a plurality of utility vehicle trailer. Each of the fault codes represents an undesired behavior of a respective utility vehicle trailer of the plurality of utility vehicle trailers or one or more components of the respective utility vehicle trailer of the plurality of utility vehicle trailers. The method includes evaluating the obtained fault codes and based on the evaluation, generating user information.

### CROSS-REFERENCE TO RELATED PATENT APPLICATION

This patent application claims the benefit of priority to European Patent Application No. 24200360.6 filed Sep. 13, 2024, the entire teachings and disclosures are incorporated herein by reference thereto.

### FIELD

Exemplary embodiments of the invention relate to the evaluation of fault codes.

### BACKGROUND

Utility vehicle trailers comprising a telematics unit, which transmit telematics data sets having state information to a server at a certain frequency, are known in the prior art. When the telematics unit has detected a fault state of the utility vehicle trailer, this state information can contain, for example, a fault code, which is assigned to the detected fault state.

### SUMMARY OF SEVERAL EXEMPLARY EMBODIMENTS OF THE INVENTION

However, these telematics data sets known from the prior art and the fault codes contained therein only permit inferences about the state of the respective utility vehicle trailer, so that only countermeasures for the respective utility vehicle trailer can also only be undertaken in case of a fault state. One object of the invention is therefore to overcome this disadvantage.

A further object of the invention is to advantageously refine the prior art.

A method is disclosed according to the invention, wherein the method is performed by one or more servers, and wherein the method comprises:
obtaining a plurality of fault codes for a plurality of utility vehicle trailers, wherein each of the fault codes represents an undesired behavior of a respective utility vehicle trailer of the plurality of utility vehicle trailers or one or more components of the respective utility vehicle trailer of the plurality of utility vehicle trailers;
evaluating the obtained fault codes;
based on the evaluation, generating user information.

The disclosed method is performed by one or more servers. The disclosed method being performed by one server is to be understood to mean that the server performs the method alone, i.e. the server or means of the server performs or perform all steps of the method. And the disclosed method being performed by more than one server is to be understood to mean that the servers perform the method jointly; i.e. the servers or means of the servers cooperate in order to perform the method. For example, one server can perform one or more steps of the method, and another server can perform one or more other steps of the method. Alternatively or additionally, it can also be provided that two servers cooperate in order to perform one or more steps of the method jointly. The multiple servers can be part of a so-called cloud.

Accordingly, a server is furthermore disclosed according to the invention, wherein the server comprises means configured to perform the disclosed method. In this case, the means of the server are configured to perform the method alone and/or in cooperation with one or more further servers. For example, the server is part of a so-called cloud.

The means can comprise hardware and/or software components. The means can comprise, for example, at least one memory having program instructions of a computer program (for example, of the computer program disclosed below) and at least one processor designed to execute program instructions from the at least one memory. Accordingly, a server is also to be understood as disclosed which comprises at least one processor and at least one memory having program instructions, wherein the at least one memory and the program instructions are configured, jointly with the at least one processor, to cause the server to perform the disclosed method alone or in cooperation with one or more further servers. It is apparent that the disclosed server can also comprise other means which are not listed.

Furthermore, a system is disclosed, wherein the system comprises at least the disclosed server and the plurality of utility vehicle trailers. It is apparent that the system can also comprise several of the disclosed servers, for example if these servers perform the disclosed method jointly.

Furthermore, a computer program is disclosed, wherein the computer program comprises program instructions which are designed, when they are executed by at least one processor, to cause a server (for example, the server disclosed above) to perform the disclosed method alone or in cooperation with one or more further servers.

The disclosed computer program is contained and/or stored, for example, on a computer-readable storage medium. A computer-readable storage medium is to be understood, for example, as a physical and/or tangible storage medium.

The disclosed method, the disclosed server, the disclosed system, and the disclosed computer program are used, for example, to evaluate fault codes.

The properties of the disclosed method (also referred to hereinafter as the “method”), the disclosed server (also referred to hereinafter as the “server”), the disclosed system (also referred to hereinafter as the “system”), and the disclosed computer program (also referred to hereinafter as the “computer program”) are described hereinafter—partially for exemplary purposes. It is apparent that the method, the server, the system, and the computer program correspond to one another, so that the disclosure of a feature for one of these categories is to be understood as the disclosure of a corresponding feature for the other categories.

A utility vehicle trailer is, for example, a trailer for a truck, such as a rigid drawbar trailer or a steerable drawbar trailer or a semitrailer. Such utility vehicles trailers are intended in particular for the transport of goods, preferably piece goods, in public road traffic. For this purpose, utility vehicle trailers have different types of utility vehicle superstructures, which are used to accommodate the goods to be transported in a cargo space. Thus, for example, box bodies having fixed side walls, a fixed front wall, a rear wall formed by wing doors, and a fixed roof, and which enclose the cargo space, are known. Since the box bodies are closed, box bodies are particularly suitable for the transport of moisture-sensitive and/or temperature-sensitive goods, thus, for example, for so-called dry transport and/or refrigerated transport. In addition to box bodies, moreover so-called tarpaulin superstructures are known, in which the side walls and the roof are closed by at least one tarpaulin. The front wall is usually designed as a fixed wall in tarpaulin superstructures, while the rear wall is regularly formed by two wing doors in order to load the cargo space from the rear if needed. If a tarpaulin can be shifted along the side wall, this is also referred to as a so-called curtain sider. Accordingly, a utility vehicle superstructure is to be understood, for example, as a box body, a tarpaulin superstructure, and/or a curtain sider.

Obtaining a plurality of fault codes for a plurality of utility vehicle trailers is to be understood to mean, for example, that at least one fault code is obtained for each utility vehicle trailer of the plurality of utility vehicle trailers. For example, the plurality of fault codes comprises at least one respective fault code for each utility vehicle trailer of the plurality of utility vehicle trailers.

For example, each of the fault codes is transmitted from a respective utility vehicle trailer of the plurality of utility vehicle trailers to at least one of the servers, so that the plurality of fault codes is obtained in that they are received by the at least one of the servers from the plurality of utility vehicle trailers.

In this case, each of the fault codes represents a respective undesired behavior of a respective utility vehicle trailer of the plurality of utility vehicle trailers or one or more components of the respective utility vehicle trailer of the plurality of utility vehicle trailers. For example, each of the fault codes is assigned to a respective undesired behavior. As soon as an undesired behavior is detected for the first time, a fault code is assigned thereto, for example. Accordingly, an undesired behavior to which a fault code is assigned is to be understood, for example, as a known undesired behavior, whereas an undesired behavior to which no fault code is assigned is to be understood, for example, as an unknown undesired behavior.

A respective undesired behavior of a respective utility vehicle trailer of the plurality of utility vehicle trailers is present, for example, if the respective utility vehicle trailer is in an undesired operating state. The operating state of the utility vehicle trailer is to be understood, for example, as a description (for example, a representation) of (for example, selected) properties of the utility vehicle trailer, which typically change in operation of the utility vehicle trailer. Properties of the utility vehicle trailer which typically change in operation of the utility vehicle trailer are also referred to hereinafter as variable properties. Such variable properties are determined, for example, by the use of the utility vehicle trailer and/or the consumption of operating material during the operation of the utility vehicle trailer. These are, for example, properties monitored by vehicle sensors in operation of the utility vehicle trailer (such as tank fill level, battery voltage, battery temperature, tire pressure, and/or axle load).

For example, as disclosed in detail below, it can be provided that each utility vehicle trailer of the plurality of utility vehicle trailers comprises a respective data processing unit (for example, a telematics unit), wherein the respective telematics unit is configured to detect, based on a respective first sensor data set, an undesired behavior (for example, an undesired operating state) of the respective utility vehicle trailer and/or one or more components of the respective utility vehicle trailer, wherein the respective first sensor data set comprises sensor data which were captured by vehicle sensors of the respective utility vehicle trailer. If the respective data processing unit of the respective utility vehicle trailer detects an undesired behavior (for example, an undesired operating state) of the respective utility vehicle trailer and/or one or more components of the respective utility vehicle trailer, the respective data processing unit of the respective utility vehicle trailer can transmit a corresponding fault code (for example, a fault code assigned to the detected undesired behavior (for example, the detected undesired operating state)) to at least one of the servers.

The evaluation of the obtained fault code is to be understood, for example, to mean that predetermined characteristic variables are determined for the plurality of fault codes. The predetermined characteristic variables can be at least partially statistical characteristic variables (for example, total population and/or number and/or growth or shrinkage rate (for example, per day or per week or per month or per year) and/or prognosis values obtained by interpolation (for example, linear or polynomial trend) and/or trend analyses). Statistical anomalies such as noticeable trends and/or noticeable deviations can be detected in the scope of the evaluation, for example, by the determination of such statistical characteristic variables. The evaluation can take place, for example, on the basis of predetermined rules (for example, an algorithm). The rules can specify, for example, which characteristic variables are determined and under which circumstances a statistical anomaly such as a noticeable trend and/or a noticeable deviation is to be detected; for example, the rules can be specified such that a statistical anomaly is detected for the plurality of utility vehicle trailers and/or one or more groups of utility vehicle trailers if it could be an indication of an increased probability of an undesired behavior for the plurality of utility vehicle trailers and/or one or more groups of utility vehicle trailers.

As a result of the evaluation, for example, the characteristic variables and/or the specification whether a statistical anomaly was detected are obtained.

In particular with a large number of utility vehicle trailers, statistical anomalies such as noticeable trends or noticeable deviations can be detected early by such a statistical evaluation and/or the determination of statistical characteristic variables, which can be an indication of an increased probability for an undesired behavior (such as the imminent failure of components) for the plurality of utility vehicle trailers and/or one or more groups of utility vehicle trailers. For example, a fault code for a group of utility vehicles which have all been produced in the same production period can occur more frequently (for example, by 10%) than would be expected according to the average for all other utility vehicles of the plurality of utility vehicles. This frequency indicates that there is an increased probability for the occurrence of the undesired behavior assigned to this fault code for the utility vehicles of this group of utility vehicles—which could indicate, for example, the installation of faulty components during this production period.

In this case, a group of utility vehicle trailers of the plurality of utility vehicle trailers can comprise, for example, all utility vehicle trailers of the plurality of utility vehicle trailers which are in the same base state and/or have the same configuration and/or belong to the same owner and/or were produced in the same period (e.g., production day, production month, or production year). Accordingly, the plurality of utility vehicle trailers can comprise multiple groups of utility vehicle trailers. For example, each utility vehicle trailer of the plurality of utility vehicle trailers can be assigned to one or more groups of utility vehicles. The assignment of the plurality of utility vehicle trailers to the groups of utility vehicle trailers can be stored, for example, in a database (for example, a database of an ERP system (enterprise resource planning system)). It is apparent that the invention is not restricted to the above-mentioned groups of utility vehicle trailers.

User information is generated based on the evaluation. The user information is used, for example, to inform at least one user about the result of the evaluation. The user thus obtains the opportunity, for example, to take possible countermeasures, such as the replacement of components which threaten to fail.

The generation of information such as the user information based on the evaluation is to be understood to mean, for example, that the information is generated in consideration of at least one result of the evaluation and/or that the information is generated only in reaction to at least one predetermined result of the evaluation.

For example, it can be provided that the user information is only generated if a statistical anomaly such as noticeable trends and/or noticeable deviations were detected in the scope of the evaluation. For example, the user information can specify in this case for which fault code(s) and/or for which group of utility vehicle trailers of the plurality of utility vehicle trailers a statistical anomaly was detected.

Alternatively or additionally, the user information can represent one or more of the above-disclosed characteristic variables (for example, specify them quantitatively and/or qualitatively).

The user can be, for example, a user associated with the plurality of utility vehicle trailers and/or a user associated with a group of utility vehicle trailers of the plurality of utility vehicle trailers, such as the owner and/or supervisor (for example, a fleet supervisor) of one or more of the plurality of utility vehicle trailers. For example, the user can be associated with at least one utility vehicle trailer of a group of utility vehicle trailers of the plurality of utility vehicle trailers, wherein, for example, a statistical anomaly was detected for the group of utility vehicle trailers.

Such a user associated with at least one utility vehicle trailer can be stored, for example, in a database (for example, a database of an ERP system (enterprise resource planning system)), so that the generation of the user information can comprise the query of a user associated with the at least one utility vehicle trailer in the database. As a result of the query, for example, contact information for transmitting the user information to a user device of the user and/or for providing the user information for retrieval by a user device of the user can be obtained.

The invention therefore provides a solution which enables a notification of an increased probability of an undesired behavior for the plurality of utility vehicle trailers and/or for one or more groups of utility vehicle trailers to be obtained early and possible countermeasures to be taken.

Further advantages of the disclosed invention are described hereinafter on the basis of exemplary embodiments of the disclosed method, the disclosed server, the disclosed system, and the disclosed computer program.

In exemplary embodiments, each utility vehicle trailer of the plurality of utility vehicle trailers comprises a respective data processing unit (for example, a telematics unit), wherein the respective data processing unit is configured to detect, based on a respective first sensor data set, an undesired behavior (for example, an undesired operating state) of the respective utility vehicle trailer and/or one or more components of the respective utility vehicle trailer, wherein the respective first sensor data set comprises sensor data which were captured by vehicle sensors of the respective utility vehicle trailer.

For example, the respective data processing unit executes a computer program having instructions which cause the respective data processing unit to detect an undesired behavior (for example, an undesired operating state) based on the respective first sensor data set. The statement that the respective data processing unit executes the computer program is to be understood, for example, to mean that the computer program is located in a memory of the respective data processing unit and at least one processor of the respective data processing unit executes instructions of the computer program which cause the respective data processing unit to detect the undesired behavior based on the respective first sensor data set.

The sensor data of a sensor data set (such as the sensor data of the respective first sensor data set and/or the sensor data of the second sensor data set disclosed below) are/were captured by various vehicle sensors of the respective utility vehicle trailer. The statement that sensor data of such a sensor data set are/were captured by vehicle sensors is to be understood, for example, to mean that each of the vehicle sensors provides/has provided respective sensor data and the respective sensor data (quantitatively and/or qualitatively) represent a property captured by the respective vehicle sensor. In other words, the sensor data of a sensor data set can (quantitatively and/or qualitatively) represent properties captured by various vehicle sensors of the respective utility vehicle trailer. Each of the properties captured by one of the vehicle sensors can be in each case, for example, a physical or chemical variable.

The various vehicle sensors of the respective utility vehicle trailer are configured, for example, to capture the properties at a specific frequency (for example, at a specific frequency and/or at specific time intervals), wherein different frequencies can be used for different vehicle sensors. The captured sensor data can be collected, for example, and combined to form a sensor data set at a specific frequency (for example, at a specific frequency and/or at specific time intervals), so that the sensor data of a sensor data set comprise, for example, only (for example, all) sensor data which were captured after the prior sensor data set was compiled. For example, the respective data processing unit of the respective utility vehicle trailer obtains the captured sensor data from the various vehicle sensors, for example to collect these data and combine them to form a sensor data set and/or to further process them (for example, to detect the undesired behavior).

The vehicle sensors of the respective utility vehicle trailer which capture the sensor data of the respective first sensor data set and/or the sensor data of the second sensor data set disclosed below are to be understood, for example, as regular vehicle sensors of the utility vehicle trailer. Regular vehicle sensors of the respective utility vehicle trailer are to be understood here, for example, as vehicle sensors which were installed as standard equipment in the respective utility vehicle trailer and/or which were/are also installed in comparable utility vehicle trailers (for example, in utility vehicle trailers having the same base state and/or having the same configuration), in particular in comparable sold utility vehicle trailers. Accordingly, each of the plurality of utility vehicle trailers or each of a group of utility vehicle trailers of the plurality of utility vehicle trailers can comprise respective vehicle sensors.

For example, the sensor data of the respective first sensor data set can represent the operating state of the respective utility vehicle trailer at the time at which the respective first sensor data set was captured. If the sensor data of the first sensor data set were captured at different points in time, for example, the time at which the last sensor data of the respective first sensor data set were captured is to be defined as the time at which the respective first sensor data set was captured.

The detection, based on the respective first sensor data set, of an undesired behavior (for example, an undesired operating state) of the respective utility vehicle trailer or one or more components of the respective utility vehicle trailer can take place, for example, on the basis of predetermined rules. For example, the detection of an undesired behavior (for example, an undesired operating state) of the respective utility vehicle trailer or one or more components of the respective utility vehicle trailer can comprise the determination of the similarity and/or the comparison of the respective first sensor data set with one or more predetermined sensor data sets. For example, each of the predetermined sensor data sets is associated with a specific undesired operating state, i.e. with a specific undesired behavior. For example, such sensor data sets can be predetermined for known undesired operating states and/or known undesired behaviors, for example because they have occurred in the past together with the undesired operating state and/or the undesired behavior. Accordingly, the rules can specify, for example, that when the determination of the similarity and/or the comparison has the result that the respective first sensor data set is similar (for example, because a degree of similarity obtained as the result of the determination of the similarity and/or the comparison exceeds a threshold value) and/or identical to a specific sensor data set of the predetermined sensor data sets, it is to be detected that the respective utility vehicle trailer or one or more components of the respective utility vehicle trailer is in the undesired operating state associated with the specific sensor data set. If it is detected that the respective utility vehicle trailer or one or more components of the respective utility vehicle trailer is in the undesired operating state associated with the specific sensor data set, the respective telematics unit of the respective utility vehicle trailer can transmit, for example, a telematics data set comprising a respective fault code, which represents the detected undesired operating state (i.e. the detected undesired behavior) of the respective utility vehicle trailer or one or more components of the respective utility vehicle trailer, to at least one of the servers.

In exemplary embodiments, the obtained fault codes are at least partially contained in telematics data sets, wherein the telematics data sets are received from the plurality of utility vehicle trailers.

For example, each fault code contained in the telematics data sets represents an undesired behavior, detected by the respective data processing unit (for example, a telematics unit) of the respective utility vehicle trailer of the plurality of utility vehicle trailers, of the respective utility vehicle trailer or one or more components of the respective utility vehicle trailer, wherein the respective data processing unit of the respective utility vehicle trailer has detected the undesired behavior based on a respective first sensor data set of the respective utility vehicle trailer, wherein the respective first sensor data set comprises sensor data which were captured by vehicle sensors of the respective utility vehicle trailer.

In exemplary embodiments, the method furthermore comprises:
holding, for each utility vehicle trailer of the plurality of utility vehicle trailers, a respective digital representation of the respective utility vehicle trailer;
receiving a second sensor data set at least for one utility vehicle trailer of the plurality of utility vehicle trailers, wherein the second sensor data set comprises sensor data which were captured by sensors of the utility vehicle trailer, and wherein the second sensor data set represents a second state of the utility vehicle trailer;
updating the digital representation of the utility vehicle trailer (i.e. the utility vehicle trailer for which the second sensor data set was received) based on the second sensor data set in order to obtain an updated digital representation of the utility vehicle trailer in the second state;
detecting, based on the updated digital representation of the utility vehicle trailer (i.e. the utility vehicle trailer for which the second sensor data set was received) an unknown undesired behavior of utility vehicle trailer and/or one or more components of the utility vehicle trailer;
in reaction to the detection of the undesired behavior, assigning a fault code to the detected unknown undesired behavior.

Holding a digital representation of a utility vehicle trailer is to be understood, for example, to mean that such a digital representation is stored in a memory of one of the servers. For example, the digital representation can be permanently stored in the memory, for example if the memory is a nonvolatile memory. Alternatively, it is also conceivable that the digital representation is only temporarily stored in the memory, for example if the memory is a volatile memory. In particular, the digital representation can be stored in a database in the memory, wherein a plurality of digital representations (for example, one for each of the plurality of utility vehicle trailers) are stored in the database.

The digital representation of the utility vehicle trailer is, for example, a digital model (for example, a so-called digital twin) of the utility vehicle trailer.

The digital representation can represent, for example, the state (for example, the base state and/or the operating state) of the utility vehicle trailer. For example, such a digital representation of the respective utility vehicle trailer can be kept ready for each utility vehicle trailer of the plurality of utility vehicle trailers.

The state of the utility vehicle trailer can describe the state of the utility vehicle trailer, for example, at a specific time. For example, the state of the utility vehicle trailer can describe the base state of the utility vehicle trailer (for example, at the specific time) and/or the operating state of the utility vehicle trailer (for example, at the specific time).

The base state of the utility vehicle trailer is to be understood, for example, as a description (for example, a representation) of (for example, selected) properties of the utility vehicle trailer, which typically do not change in operation of the utility vehicle trailer. Properties of the utility vehicle trailer which typically do not change in operation of the utility vehicle trailer are also referred to hereafter as invariable properties. Such invariable properties are determined, for example, by the utility vehicle trailer itself and/or the components installed in the utility vehicle trailer. For example, the base state can essentially describe the invariable properties of the utility vehicle trailer which result from the configuration and/or production of the utility vehicle trailer. These are, for example, technical data of the utility vehicle trailer (such as tank capacity, battery capacity, tire size, and/or vehicle weight) and/or operating points of the utility vehicle trailer (such as setpoint battery voltage, maximum battery temperature, setpoint tire pressure, and/or maximum axle load).

The operating state of the vehicle, as disclosed above in detail, is to be understood, for example, as a description (for example, a representation) of (for example, selected) properties of the vehicle which typically change in operation of the vehicle.

For example, the sensor data of the second sensor data set can represent the operating state of the utility vehicle trailer at the time at which the second sensor data set was captured. If the sensor data of the second sensor data set were captured at different times, for example, the time at which the last sensor data of the second sensor data set were captured and/or at which the first sensor data set is received is to be determined as the time at which the second sensor data set was captured.

The updating of the digital representation of the utility vehicle trailer based on the second sensor data set is to be understood, for example, to mean that the operating state of the utility vehicle trailer represented by the digital representation of the utility vehicle trailer is adapted in accordance with the sensor data of the second sensor data set. As a result of the updating, for example, an updated digital representation of the utility vehicle trailer is then obtained, which represents the same operating state of the utility vehicle trailer as the sensor data of the second sensor data set. For example, the updated digital representation can contain the second sensor data set.

The statement that the detection of an unknown undesired behavior of the utility vehicle trailer and/or one or more components of the utility vehicle trailer is based on the updated digital representation of the utility vehicle trailer is to be understood to mean, for example, that the updated digital representation of the utility vehicle trailer is to be taken into consideration in the detection. However, it is apparent that in addition other information can also be taken into consideration in the detection.

The detection, based on the updated digital representation of the utility vehicle trailer, of an unknown undesired behavior of the vehicle and/or one or more components of the utility vehicle trailer can take place, for example, on the basis of predetermined rules. For example, the detection of an unknown undesired behavior of the utility vehicle trailer and/or one or more components of the utility vehicle trailer can comprise the determination of the similarity and/or the comparison of the operating state represented by the updated digital representation of the utility vehicle trailer with one or more known and/or desired operating states. The known and/or desired operating state(s) can be predefined, for example. For example, the known and/or desired operating state(s) is/are at least partially defined by operating points of the utility vehicle trailer (such as setpoint battery voltage, maximum battery temperature, setpoint tire pressure, and/or maximum axle load), which are described by the digital representation of the utility vehicle trailer. The rules can specify, for example, that when the determination of the similarity and/or the comparison has the result that the updated operating state does not correspond to any of the known and/or desired operating states, an unknown undesired behavior is detected. Alternatively, the rules can also specify, for example, that an unknown undesired behavior is detected if the determination of the similarity and/or the comparison has the result that the updated operating state is not similar to any of the known and/or desired operating states (for example, because (the/all) degree(s) of similarity obtained as the result of the determination of the similarity and/or the comparison exceeds/exceed a threshold value). The invention is not restricted thereto, however. For example, the detection can also take place on the basis of a detection model (for example, in the form of an artificial neural network).

In reaction to the detection of the unknown undesired behavior, a fault code is assigned to the detected unknown undesired behavior. This enables, for example, the unknown undesired behavior to be identified when it is detected once again.

As disclosed above, each utility vehicle trailer of the plurality of utility vehicle trailers can comprise a respective data processing unit (for example, a telematics unit). If a fault code is assigned to an unknown undesired behavior, the data processing units of the plurality of utility vehicle trailers can be adapted, for example, such that in future they can also detect this undesired behavior based on a respective first sensor data set. For this purpose, in reaction to the detection of the unknown undesired behavior, program code can be generated which contains instructions that cause the respective data processing unit to detect the unknown undesired behavior based on a respective first sensor data set captured by vehicle sensors of the respective utility vehicle trailer. For example, the program code is configured to cause the respective data processing unit to detect the unknown undesired behavior at least if the respective data processing unit executes the program code and obtains a respective first sensor data set which corresponds to the second sensor data set.

For example, the program code can comprise instructions of a computer program executable by the respective data processing unit and/or a part of a computer program executable by the respective data processing unit of the vehicle. The program code can be made available (for example, transmitted and/or provided) to the data processing units of at least a part (for example, a group of utility vehicle trailers) of the plurality of utility vehicle trailers in the context of an update (for example, a software update).

In exemplary embodiments, the first sensor data set and/or the second sensor data set comprises at least sensor data of one or more vehicle sensors of the following vehicle sensor types:
temperature sensor;
battery sensor;
voltage sensor;
current sensor;
door sensor;
tank fill level sensor;
tire pressure sensor;
weight sensor.

In exemplary embodiments, the vehicle sensors can at least partially be part of an electronic braking system and/or a transport refrigerator of the utility vehicle trailer.

In exemplary embodiments, the evaluation comprises (i) a statistical evaluation of the obtained fault codes and/or (ii) the determination of statistical characteristic variables for the plurality of fault codes.

As disclosed above, the evaluation of the obtained fault codes is to be understood, for example, to mean that for the plurality of fault codes, predetermined characteristic variables (for example, total population and/or number and/or growth or shrinkage rate (for example, per day or per week or per month or per year) and/or prognosis values obtained by (for example, linear and/or polynomial trend) interpolation and/or trend analyses) are determined. Statistical anomalies such as noticeable trends and/or noticeable deviations can be detected by the determination of such statistical characteristic variables in the context of the evaluation, for example. The evaluation can take place, for example, on the basis of predetermined rules (for example, an algorithm). The rules can specify, for example, which characteristic variables are determined and under which circumstances a statistical anomaly such as a noticeable trend and/or a noticeable deviation is to be detected.

For example, the determination of statistical characteristic variables is repeated at specific time intervals (for example, one day and/or one week and/or one month and/or one year), wherein with each repetition, in each case only the characteristic variables are determined for the fault codes which were obtained since the last repetition.

For example, the plurality of fault codes only comprises the fault codes which were obtained in a period of time defined by such a time interval. This repeated determination of characteristic variables enables, for example, in the context of the evaluation, noticeable deviations (for example, deviations which fall below or exceed a predetermined threshold value such as 10%) between characteristic variables which were determined in different repetitions, and/or trends (for example, steady changes such as rising and/or sinking (for example, growth rates), which exceed a threshold value such as 5% rising and/or sinking per day or per week or per month or per year) of a characteristic variable over multiple repetitions) between characteristic variables which were determined in different repetitions, to be detected.

For example, the statistical characteristic variables are each determined for different groups of utility vehicle trailers of the plurality of utility vehicle trailers, wherein for each of the groups of utility vehicle trailers of the plurality of utility vehicle trailers, in each case only the characteristic variables are determined for the fault codes which were received for the utility vehicle trailers of these groups of utility vehicle trailers of the plurality of utility vehicle trailers.

This determination of characteristic variables for different groups of utility vehicle trailers of the plurality of utility vehicle trailers enables, for example, in the context of the evaluation, noticeable deviations (for example, deviations which fall below or exceed a predetermined threshold value such as 10%) between characteristic variables which are determined for different groups of utility vehicle trailers of the plurality of utility vehicle trailers to be detected.

As disclosed above, a group of utility vehicle trailers of the plurality of utility vehicle trailers can comprise, for example, all utility vehicle trailers of the plurality of utility vehicle trailers which are in the same base state and/or have the same configuration and/or belong to the same owner and/or were produced in the same period (e.g., production day, production month, or production year). Accordingly, the plurality of utility vehicle trailers can comprise multiple groups of utility vehicle trailers; and one utility vehicle trailer of the plurality of utility vehicle trailers can belong to multiple groups of utility vehicle trailers. It is apparent that the invention is not restricted to the above-mentioned groups of utility vehicle trailers.

For example, each utility vehicle trailer of the plurality of utility vehicle trailers can be assigned to one or more groups of utility vehicles. The group assignments of the plurality of utility vehicle trailers to the groups of utility vehicle trailers can be stored, for example, in a database (for example, a database of an ERP system (enterprise resource planning system)), so that the evaluation can comprise the querying of the group assignments in the database.

In exemplary embodiments, the following are obtained as the result of the evaluation:
the statistical characteristic variables and/or
an indication of whether a statistical anomaly was detected.

For example, the statistical characteristic variables for multiple groups of utility vehicle trailers (for example, for each group of utility vehicle trailers) can be obtained as the result of the evaluation.

Alternatively or additionally, the indication that a statistical anomaly was detected can also indicate for which group of utility vehicle trailers the statistical anomaly was detected.

In exemplary embodiments, the user information represents and/or comprises an action recommendation for one or more (for example, a group of utility vehicle trailers) of the plurality of utility vehicle trailers. For example, the action recommendation can specify which countermeasures are to be taken with regard to a fault code for which a statistical anomaly was detected, and/or a group of utility vehicle trailers for which a statistical anomaly was detected, for example whether and when a group of utility vehicle trailers is to be called to the repair shop.

In exemplary embodiments, the user information represents and/or comprises a diagnostic sequence having multiple diagnostic steps in a predetermined order.

The user information can comprise at least one diagnostic sequence assigned to a fault code (for example, a fault code for which a statistical anomaly was detected). For example, at least one such diagnostic sequence can be assigned to each fault code. It can also be provided that multiple such diagnostic sequences are assigned to one fault code. The assignment of the fault code to the diagnostic sequences can be stored, for example, in a database (for example, a fault code and/or diagnostic database of a vehicle producer and/or an operator of a vehicle fleet), so that the generation of the user information can comprise the querying of the diagnostic sequences assigned to the fault code (for example, the fault code for which a statistical anomaly was detected) in the database.

In exemplary embodiments, the method furthermore comprises at least one of the following steps:
outputting or causing the output of the user information to a user (for example, a user associated with the vehicle);
providing the user information for output to a user (for example, a user associated with the vehicle).

As disclosed above, the user information is used, for example, to inform at least one user about the result of the evaluation. The output of such user information is to be understood, for example, to mean that it is output by output means such as a display screen and/or loudspeaker. For example, the user information can be displayed as text and/or graphics on a display screen and/or played back as speech information through a loudspeaker.

For example, at least one of the servers can output the user information. Alternatively or additionally, the user information can also be output by another device (for example, a device different from the servers) such as a user device. For this purpose, causing the output of the user information can comprise sending the user information to the other device; and/or the provision of the user information for output of the user information can take place such that the other device can retrieve the user information. The sending and/or retrieving of the user information can take place via a communication path. The communication path for sending and/or retrieving the user information can be, for example, (i) wired or (ii) can comprise at least one wired section, for example if the at least one server communicates in a wired manner. It is apparent that the communication path can also comprise at least one wireless section, for example if the other device communicates wirelessly.

### BRIEF DESCRIPTION OF THE DRAWINGS

In the figures:

FIG. 1 shows a schematic representation of an exemplary embodiment of a system according to the invention;

FIG. 2 shows a schematic representation of an exemplary embodiment of a server according to the invention;

FIG. 3 shows a schematic representation of an exemplary embodiment of a data processing unit for a vehicle according to the invention;

FIG. 4 shows a flow chart of an exemplary embodiment of a method according to the invention.

### DETAILED DESCRIPTION OF SEVERAL EXEMPLARY EMBODIMENTS

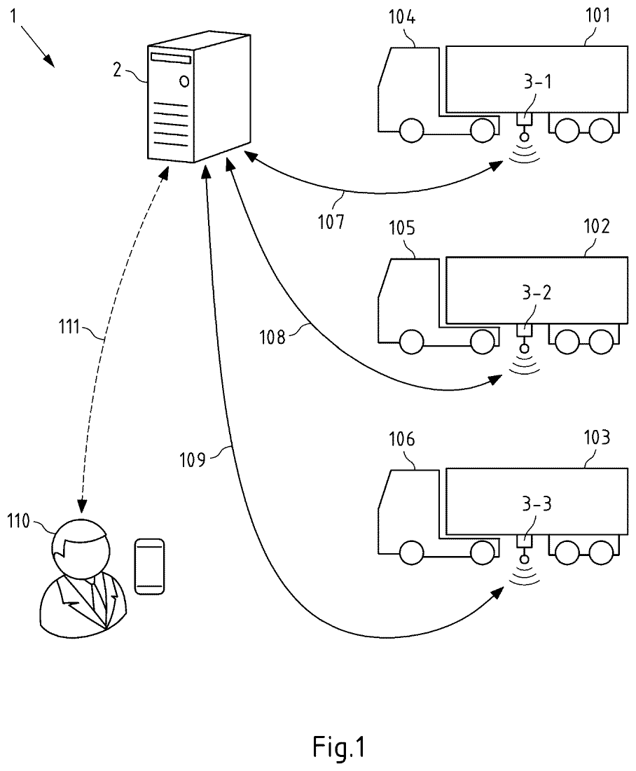

FIG. 1 shows a schematic representation of an exemplary embodiment of a system according to the invention.

The system 1 comprises, among other things, utility vehicle trailers 101 to 103. The utility vehicle trailers 101 to 103 are shown in FIG. 1 by way of example as semitrailers, which are pulled by one of the respective tractor vehicles 104 to 106. It is presumed by way of example hereinafter that the semitrailers 101 to 103 are part of a plurality of semitrailers with further semitrailers which are not shown and that the semitrailers 101 to 103 form a group of semitrailers of the plurality of semitrailers, for example because they belong to the same vehicle fleet, have the same configuration, and were produced in the same production period.

Furthermore, the system 1 comprises a server 2 remote from the semitrailers 101 to 103 and the tractor vehicles 104 to 106. It is apparent that the system could also comprise multiple servers 2 and/or a cloud. However, it is presumed by way of example hereinafter that the system only comprises the server 2.

In FIG. 1, respective communication paths 107 to 109 are shown between the semitrailers 101 to 103 and the server 2. The semitrailers 101 and the server 2 can exchange (for example, transmit and receive) information (for example, telematics data sets and/or software updates) via the communication path 107. In the same manner, the semitrailers 102 and 103 and the server 2 can exchange (for example, transmit and receive) via the respective communication paths 108 and 109 (for example, telematics data sets and/or software updates). For example, each of the semitrailers 101 to 103 comprises a respective telematics unit 3 (cf. 3-1, 3-2, and 3-3), which is configured to exchange information with the server 2 via the respective communication path.

It is presumed by way of example hereinafter that each of the communication paths 107 to 109 comprises a respective wireless connection such as a WLAN and/or mobile wireless connection. WLAN is specified, for example, in the standards of the IEEE-802.11 family and is presently available on the Internet at www.ieee.org. Mobile wireless is to be understood in particular as mobile wireless communications systems such as a 2G/3G/4G/5G/6G communication system. The specifications of the 2G, 3G, 4G, 5G, or 6G mobile wireless communication systems are presently developed by the 3rd Generation Partnership Project (3GPP) and can presently be retrieved on the Internet at https://www.3gpp.org/.

It is apparent that each of the communication paths 107 to 109, in addition to the wireless connection, can also comprise a wired connection via a wired communication network such as an ethernet network and/or the Internet. Ethernet is specified, for example, in the standards of the IEEE-802.3 family and is presently available on the Internet at www.ieee.org.

The information exchange via the communication paths 107 to 109 can take place in an encrypted manner.

In addition, a user device 110 of a user such as a vehicle fleet supervisor is optionally shown in FIG. 1. For example, the semitrailers 101, 102, and 103 belong to a vehicle fleet supervised by the user 110. The server 2 can communicate with the user device 110 of the user via the optional communication path 111.

The telematics units 3-1, 3-2, and 3-3 of the semitrailers 101 to 103 transmit telematics data sets at a specific frequency (for example, at a specific frequency and/or at specific time intervals) via the communication paths 107 to 109 to the server 2. The server 2 can transmit, for example, software updates to the telematics units 3-1, 3-2, and 3-3 of the semitrailers 101 to 103 via the communication paths 107 to 109. Furthermore, the server 2 can transmit user information to the user device 111 via the communication path 111.

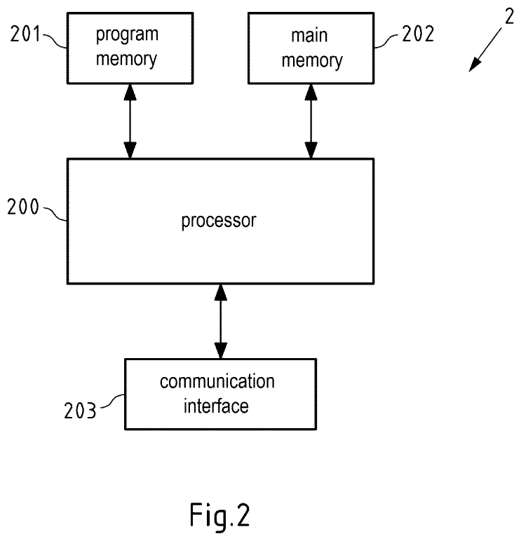

FIG. 2 shows a schematic representation of an embodiment of a server 2 according to the invention. It is presumed by way of example hereinafter that the server 2 of the system 1 shown in FIG. 1 corresponds to this server 2 shown in FIG. 2.

The server 2 comprises a processor 200 and, connected to the processor 200, a first memory as a program memory 201, a second memory as a main memory 202, and a network interface 203.

A processor is to be understood, for example, as a microprocessor (central processing unit, CPU), a micro-control unit, a microcontroller, digital signal processor (DSP), an application-specific integrated circuit (ASIC), a field programmable gate array (FPGA), or a graphics processor (graphics processing unit, GPU). It is apparent that the server device 2 can also comprise multiple processors 200.

Processor 200 executes instructions which are stored in program memory 201, and stores, for example, intermediate results or the like in main memory 202. The use of an (additional) graphics processor can be advantageous, for example, to execute algorithms for machine learning and/or artificial neural networks.

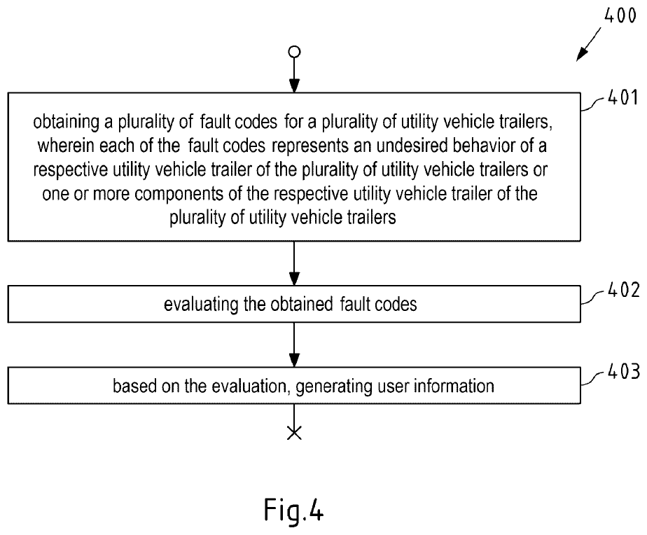

Instructions are stored in program memory 201, for example, which cause the processor 200, when it executes the program instructions, to at least partially perform the method according to the invention (for example, the method according to the flow chart 4 shown in FIG. 4). It is furthermore presumed hereinafter that a detection model in the form of an artificial neural network is stored in the program memory 201, which is trained by machine learning and can be used to detect an unknown undesired behavior of a semitrailer and/or one or more components of the semitrailer.

In addition, program memory 201 can contain a digital representation in each case for each of the semitrailers 101, 102, and 103 of the system 1 shown in FIG. 1.

Program memory 201 furthermore contains, for example, the operating system of the server 2, which is at least partially loaded into the main memory 202 and executed by the processor 200 upon starting of the server 3. In particular, at least a part of the core of the operating system is loaded into the main memory 202 and executed by processor 200 upon starting of the server 2.

One example of an operating system is a Windows, UNIX, Linux, Android, Apple iOS, and/or MAC OS operating system. The operating system enables in particular the use of the server 2 for data processing. It manages, for example, operating equipment such as a main memory and a program memory, provides, among other things, fundamental functions by way of programming interfaces to other computer programs, and controls the execution of computer programs.

A program memory is, for example, a nonvolatile memory such as a flash memory, a magnetic memory, an EEPROM memory (electrically erasable programmable read-only memory), and/or an optical memory. A main memory is, for example, a volatile or nonvolatile memory, in particular a random-access memory (RAM) such as a static RAM memory (SRAM), a dynamic RAM memory (DRAM), a ferroelectric RAM memory (FeRAM), and/or a magnetic RAM memory (MRAM).

Main memory 202 and program memory 201 can also be formed as one memory. Alternatively, main memory 202 and/or program memory 201 can each be formed by multiple memories. Furthermore, main memory 202 and/or program memory 201 can also be part of the processor 200.

Processor 200 controls the communication interface 203, which is configured, for example, to exchange (for example, to transmit and/or receive) information with a remote device via a connection in a communication network. It is presumed hereinafter by way of example that the communication interface 203 is a wired communication interface. One example of a wired communication interface is an ethernet interface. As disclosed above, ethernet is specified, for example, in the standards of the IEEE-802.3 family. For example, the server 2 can use the communication interface 203 in order to exchange (for example, to transmit and/or receive) information (for example, telematics data sets and/or software updates and/or user information) via the communication paths 107 to 109 and 111 with the semitrailers 101 to 103 and the user device 110 of the system 1 shown in FIG. 1.

The components 200 to 203 of the server 2 are communicatively and/or operatively connected to one another, for example, via one or more bus systems (for example, one or more serial and/or parallel bus connections).

It is apparent that the server 2 can comprise further components (for example a user interface) in addition to the components 200 to 203.

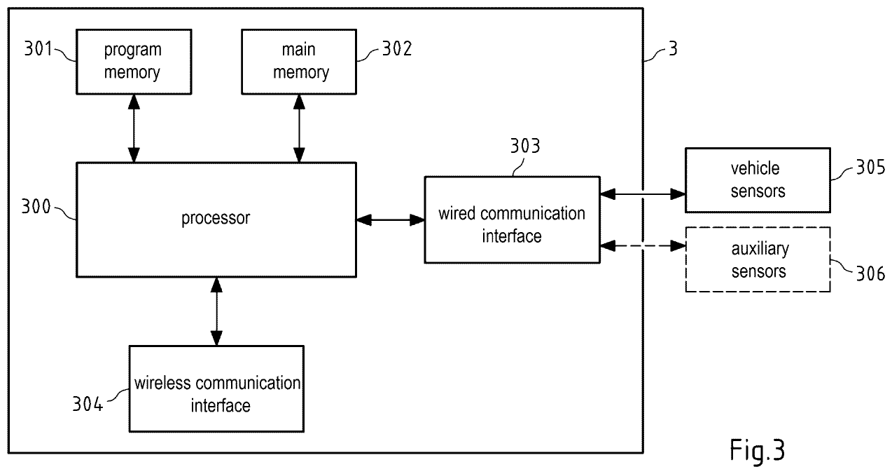

FIG. 3 shows a schematic representation of an exemplary embodiment of a data processing unit 3 for a utility vehicle trailer according to the invention. It is presumed by way of example hereinafter that the data processing unit 3 is a telematics unit and the telematics units 3-1, 3-2, and 3-3 of the semitrailers 101, 102, and 103 of the system 1 shown in FIG. 1 correspond to this telematics unit 3 shown in FIG. 3.

The telematics unit 3 comprises a processor 300 and, connected to the processor 300, a first memory as a program memory 301, a second memory as a main memory 302, and a wired communication interface 303 and a wireless communication interface 304.

The processor 300 executes instructions which are stored in program memory 301 and stores, for example, intermediate results or the like in main memory 302. It is apparent that the telematics unit 3 can also comprise multiple processors 100.

For example, the operating system of the telematics unit 3 is stored in the program memory 301, which is at least partially loaded into main memory 302 and executed by the processor 300 upon starting of the telematics unit 3. In particular, at least a part of the core of the operating system is loaded into the main memory 302 and executed by the processor 300 upon starting of the telematics unit 3.

As disclosed in detail above, one example of an operating system is a Windows, UNIX, Linux, Android, Apple iOS, and/or MAC OS operating system. The operating system in particular enables the use of the telematics unit 3 for data processing.

In addition to the operating system of the telematics unit 3, the program memory 301 can also contain further instructions. Examples of such instructions are, for example, instructions of a computer program such as a telematics program and/or a diagnostic program.

The instructions of the diagnostic program cause the processor 300, when it executes the instructions, for example, to detect an undesired behavior based on sensor data received via the wired communication interface 303. The received sensor data form, for example, a first sensor data set. For example, the detection of an undesired behavior (for example, an undesired operating state) can comprise the determination of the similarity and/or the comparison of the respective first sensor data set with one or more predetermined sensor data sets. For example, each of the predetermined sensor data sets is associated with a specific undesired behavior. For example, such sensor data sets can be predetermined for known undesired behavior, for example because they have occurred in the past together with the undesired behavior. Accordingly, the instructions of the diagnostic program, when they are executed by the processor 300, can cause the processor 300 to detect an undesired behavior and to output a fault code assigned to the detected undesired behavior if the determination of the similarity and/or the comparison has the result that the first sensor data set is similar (for example, because a degree of similarity obtained as the result of the determination of the similarity and/or the comparison exceeds a threshold value) and/or identical to a specific sensor data set of the predetermined sensor data sets.

The instructions of the telematics program cause the processor 300, when it executes the instructions, for example, to temporarily store sensor data received via the wired communication interface 303 (for example, in the program memory 301 and/or main memory 302) and also fault codes output by the diagnostic program and to transmit at a specific frequency (for example, at a specific frequency and/or at specific time intervals) a telematics data set, which contains the sensor data and fault codes which were temporarily stored, after the prior telematics data set was transmitted, via the wireless communication interface 304 to the server 2. In addition to the sensor data and the fault codes, the respective telematics data set can also contain further information (for example, state information).

It is apparent that the telematics program and the diagnostic program can also be functions of a common computer program. Alternatively, the functions of the telematics program and the diagnostic program can be distributed onto multiple computer programs.

The main memory 302 and the program memory 301 can also be formed as one memory. Alternatively, the main memory 302 and/or the program memory 301 can each be formed by multiple memories. Furthermore, the main memory 302 and/or the program memory 301 can also be part of the processor 100.

The processor 300 controls the wired communication interface 303, which is configured, for example, to exchange (for example, to transmit and/or receive) information with other components of the respective semitrailer. The communication interface 303 is designed, for example, as an Ethernet, CAN, K line, LIN, or Flexray interface. It is configured, for example, for wired communication with one or more vehicle sensors 305 of the respective semitrailer via an ethernet network or a CAN, K line, LIN, or Flexray bus system of the respective semitrailer. For example, the telematics unit 3 can transmit information to the vehicle sensors 305 and/or receive it therefrom through the wired communication interface 303. As disclosed above, ethernet is specified, for example, in the standards of the IEEE-802.3 family. CAN is specified in the standards of the ISO 11898 family, K line is specified in the standards ISO 9141 and ISO 14230-1, LIN is specified in the standards of the ISO 17987 family, and FlexRay is specified in the standards of the ISO 17458 family.

In FIG. 3, the vehicle sensors 305 are not shown as part of the telematics unit 3. However, it is apparent that the vehicle sensors 305 can also be completely or partially part of the telematics unit. Furthermore, optional auxiliary sensors are shown in FIG. 3.

Examples of the vehicle sensors 305 are a temperature sensor and/or a battery sensor and/or a voltage sensor and/or a current sensor and/or a door sensor and/or a tank fill level sensor and/or a tire pressure sensor and/or a weight sensor. It is apparent that the vehicle sensors 305 are not restricted to these sensor types.

The vehicle sensors 305 can be at least partially part of the respective semitrailer.

Furthermore, the telematics unit 3 has a wireless communication interface 304 controlled by the processor 300, via which information can be exchanged (for example, transmitted and/or received) via a wireless communication path with a remote device such as the server 2 in the system shown in FIG. 1. The wireless communication interface 304 is designed, for example, as a WLAN and/or mobile wireless interface. WLAN is, as disclosed above, standardized in the standards of the IEEE 802.11 family. Mobile wireless is to be understood in particular as mobile wireless communications systems such as a 2G/3G/4G/5G/6G communication system. The specifications of the 2G, 3G, 4G, 5G, or 6G mobile wireless communication systems are presently developed by the 3rd Generation Partnership Project (3GPP) and can presently be retrieved on the Internet at https://www.3gpp.org/.

The components 300 to 304 of the telematics unit 3 are communicatively and/or operatively connected to one another, for example, via one or more bus systems (for example, one or more serial and/or parallel bus connections).

It is apparent that the telematics unit 3 can comprise further components (for example a user interface) in addition to the components shown.

FIG. 4 shows a flow chart 400 of an exemplary embodiment of a method according to the invention. It is presumed hereinafter by way of example that the method is performed by the server 2, which is part of the system 1 shown in FIG. 1.

In a step 401, a plurality of fault codes for a plurality of utility vehicle trailers is obtained, wherein each of the fault codes represents an undesired behavior of a respective utility vehicle trailer of the plurality of utility vehicle trailers or one or more components of the respective utility vehicle trailer of the plurality of utility vehicle trailers.

For example, in step 401, the server 2 receives a first telematics data set having a fault code via the communication path 107 from the telematics unit 3-1 of the semitrailer 101 and a second telematics data set having a fault code via the communication path 108 from the telematics unit 3-2 of the semitrailer 102.

For example, the processor 300 of the telematics data unit 3-1 of the semitrailer 101 has received sensor data captured by vehicle sensors 305 of the semitrailer 101 via the wired communication interface 303 and, based on the received sensor data, has detected an undesired behavior of the semitrailer 101 and/or one or more components of the semitrailer 101 and output a fault code assigned to the detected undesired behavior. The processor 300 of the telematics data unit 3-1 of the semitrailer 101 has then generated a telematics data set having the sensor data and the fault code and transmitted it via the communication path 107 to the server 2. Similarly, the telematics data unit 3-2 of the semitrailer 102 can have detected an undesired behavior of the semitrailer 102 and/or one or more components of the semitrailer 102 and as a result can have generated a telematics data set having sensor data and the fault code and transmitted it via the communication path 108 to the server 2.

For example, the telematics units 3-1 and 3-2 can have detected the same undesired behavior, so that the first telematics data set and the second telematics data set can contain, for example, the same fault code. For example, the undesired behavior represented by this fault code can be a battery fault of a respective battery of the semitrailers 101 and 102.

It is apparent that the server 2 in step 401, in addition to the first telematics data set and the second telematics data set, can also receive still further telematics data sets having fault codes from other semitrailers (not shown in FIG. 1) of the plurality of semitrailers.

In a step 402, the fault codes obtained in step 401 are evaluated.

As disclosed in detail above, the evaluation of the obtained fault codes in step 402 can be understood to mean, for example, that predetermined characteristic variables (for example, total population and/or number and/or growth or shrinkage rate (for example, per day or per week or per month or per year) and/or prognosis values obtained by (for example, linear or polynomial trend) interpolation and/or trend analyses) are determined for the plurality of fault codes. Statistical anomalies such as noticeable trends and/or noticeable deviations can be detected, for example, in the scope of the evaluation by the determination of such statistical characteristic variables. The evaluation can take place, for example, on the basis of predetermined rules (for example, an algorithm). The rules can specify, for example, which characteristic variables are to be determined and under which circumstances a statistical anomaly such as a noticeable trend and/or a noticeable deviation is to be detected.

For example, the determination of statistical characteristic variables is repeated at specific time intervals, wherein with each repetition only the characteristic variables are determined in each case for the fault codes which were obtained since the last repetition. For example, the plurality of fault codes only comprises the fault codes which were obtained in a period of time defined by such a time interval.

For example, the statistical characteristic variables are determined in each case for different groups of semitrailers of the plurality of semitrailers, wherein for each of the groups of semitrailers of the plurality of semitrailers, in each case only the characteristic variables are determined for the fault codes which were received for the semitrailers of these groups of semitrailers of the plurality of semitrailers.

This determination of characteristic variables for different groups of semitrailers of the plurality of semitrailers enables, for example, in the scope of the evaluation, noticeable deviations (for example, deviations which fall below or exceed a predetermined threshold value, such as 10%) between characteristic variables, which are determined for different groups of semitrailers of the plurality of semitrailers, to be detected.

For example, in step 402, the fault quotient can be determined as a characteristic variable for the fault code which is contained in the first telematics data set and the second telematics data set. For example, the fault quotient can be determined for the plurality of semitrailers and for the group of semitrailers formed by the semitrailers 101 to 103. The fault quotient determined based on the fault code for the plurality of semitrailers is, for example, 2/100=2%, whereas the fault quotient determined based on this fault code for the group of semitrailers formed by the semitrailers 101 to 103 is 2/3≈66.67%. Due to this significant deviation, in the scope of the evaluation in step 402, for example, a statistical anomaly is detected for this fault code and the group of semitrailers formed by the semitrailers 101 to 103. As disclosed above, the undesired behavior represented by this fault code can be a battery fault of a battery of the respective semitrailer. This battery fault has already occurred for the semitrailers 101 and 102, so that in comparison to the plurality of semitrailers, there is an increased probability that this battery fault will also occur in the semitrailer 103.

As a result of the evaluation in step 402, for example, the specification is obtained that a statistical anomaly is detected for the fault code which is contained in the first telematics data set and the second telematics data set and for the group of semitrailers formed by the semitrailers 101 to 103.

In a step 403, user information is generated based on the evaluation.

The generation of the user information based on the evaluation in step 403 is to be understood, as disclosed above, for example, to mean that the user information is generated in consideration of at least one result of the evaluation and/or that the information is only generated in reaction to at least one predetermined result of the evaluation. For example, it can be provided that the user information is only generated if a statistical anomaly such as noticeable trends and/or noticeable deviations have been detected in the scope of the evaluation.

In step 403, for example, user information is generated which indicates that a statistical anomaly has been detected for the fault code which is contained in the first telematics data set and the second telematics data set and for the group of semitrailers formed by the semitrailers 101 to 103. Furthermore, the user information can specify, for example, as an action recommendation that the relevant semitrailers in which the battery fault has not yet occurred be called immediately into the repair shop.

The server 2 can transmit the user information generated in step 403 via the communication path 111 to the user device 110. The user device 110 can then output the user information to the user who supervises the vehicle fleet having the semitrailers 101, 102, and 103.

The exemplary embodiments of the present invention described in this specification are also to be understood as disclosed in all combinations with one another. In particular, the description of a feature comprised by one embodiment is not to be understood in the present case to mean—unless explicitly explained otherwise—that the feature is indispensable or essential for the function of the exemplary embodiment. The order of the steps described in this specification in the individual flow charts is not obligatory; alternative orders of the steps are conceivable—unless indicated otherwise. The steps can be implemented in various ways, thus an implementation in software (by program instructions), hardware, or a combination of both for implementing the steps is conceivable.

Terms used in the claims such as “comprise”, “include”, “incorporate”, “contain”, and the like do not exclude further elements or steps. The wording “at least partially” is to include both the case “partially” and also the case “completely”. The wording “and/or” is to be understood to mean that both the alternative and the combination are to be disclosed, thus “A and/or B” means “(A) or (B) or (A and B)”. A plurality of units, persons, or the like in the context of this specification means multiple units, persons, or the like. The use of an indefinite article does not exclude a plurality. A single component can execute the functions of multiple units or devices mentioned in the claims. Reference signs indicated in the claims are not to be viewed as restrictions of the means and steps used.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A method performed by one or more servers wherein the method comprises:
obtaining a plurality of fault codes for a plurality of utility vehicle trailers wherein each of the fault codes represents an undesired behavior of a respective utility vehicle trailer of the plurality of utility vehicle trailers or one or more components of the respective utility vehicle trailer of the plurality of utility vehicle trailers
evaluating the obtained fault codes;
based on the evaluation, generating user information.

2. The method as claimed in claim 1, wherein the obtained fault codes are at least partially contained in telematics data sets, wherein the telematics data sets are received from the plurality of utility vehicle trailers.

3. The method as claimed in claim 2, wherein each fault code contained in the telematics data sets represents an undesired behavior of the respective utility vehicle trailer or one or more components of the respective utility vehicle trailer detected by a data processing unit of the respective utility vehicle trailer of the plurality of utility vehicle trailers, wherein the data processing unit of the respective utility vehicle trailer has detected the undesired behavior based on a respective first sensor data set of the respective utility vehicle trailer, wherein the respective first sensor data set comprises sensor data which were captured by vehicle sensors of the respective utility vehicle trailer.

4. The method as claimed in claim 1, wherein the method furthermore comprises:
holding, for each utility vehicle trailer of the plurality of utility vehicle trailers, a respective digital representation of the respective utility vehicle trailer;
receiving a second sensor data set at least for one utility vehicle trailer of the plurality of utility vehicle trailers, wherein the second sensor data set comprises sensor data which were captured by vehicle sensors of the utility vehicle trailer, and wherein the second sensor data set represents a second state of the utility vehicle trailer;
updating the digital representation of the utility vehicle trailer based on the second sensor data set in order to obtain an updated digital representation of the utility vehicle trailer in the second state;
detecting, based on the updated digital representation of the utility vehicle trailer, an unknown undesired behavior of the utility vehicle trailer or one or more components of the utility vehicle trailer;
in reaction to the detection of the unknown undesired behavior, assigning a fault code to the detected undesired behavior.

5. The method of claim 3, wherein at least one of the respective first sensor data set or the second sensor data set comprises at least sensor data of one or more vehicle sensors of the following vehicle sensor types:
temperature sensor;
battery sensor;
voltage sensor;
current sensor;
door sensor;
tank fill level sensor;
tire pressure sensor;
weight sensor.

6. The method as claimed in claim 1, wherein the evaluation comprises at least one of a statistical evaluation of the obtained fault codes or the determination of statistical characteristic variables for the plurality of fault codes.

7. The method as claimed in claim 6, wherein the determination of statistical characteristic variables is repeated at specific time intervals, wherein with each repetition, in each case only the characteristic variables are determined for the fault codes which were obtained since the last repetition.

8. The method as claimed in claim 6, wherein the statistical characteristic variables are each determined for different groups of utility vehicle trailers of the plurality of utility vehicle trailers, wherein for each of the groups of utility vehicle trailers of the plurality of utility vehicle trailers, in each case only the characteristic variables are determined for the fault codes which were received for the utility vehicle trailers of these groups of utility vehicle trailers of the plurality of utility vehicle trailers.

9. The method as claimed in claim 6, wherein at least one of the following are obtained as the result of the evaluation
the statistical characteristic variables; or
an indication of whether a statistical anomaly was detected.

10. The method as claimed in claim 1, wherein the user information at least one of represents and/or comprises an action recommendation for one or more of the plurality of utility vehicle trailers.

11. The method as claimed in claim 1, wherein the user information at least one of represents and/or comprises a diagnostic sequence having multiple diagnostic steps in a predetermined order.

12. The method as claimed in claim 1, wherein the method furthermore comprises at least one of the following steps:
outputting or causing the output of the user information to a user;
providing the user information for output to a user.

13. A computer program comprising program instructions which are designed, when they are executed by at least one processor of a server, to cause the server to perform the following method alone or in cooperation with one or more further servers:
obtaining a plurality of fault codes for a plurality of utility vehicle trailers, wherein each of the fault codes represents an undesired behavior of a respective utility vehicle trailer of the plurality of utility vehicle trailers or one or more components of the respective utility vehicle trailer of the plurality of utility vehicle trailers;
evaluating the obtained fault codes;
based on the evaluation, generating user information.

14. A server comprising at least one processor and at least one memory containing program instructions, wherein the at least one memory and the program instructions are configured, together with the at least one processor, to cause the server perform the following method alone or in cooperation with one or more further servers:
obtaining a plurality of fault codes for a plurality of utility vehicle trailers, wherein each of the fault codes represents an undesired behavior of a respective utility vehicle trailer of the plurality of utility vehicle trailers or one or more components of the respective utility vehicle trailer of the plurality of utility vehicle trailers;
evaluating the obtained fault codes;
based on the evaluation, generating user information.

15. (canceled)

16. The server as claimed in claim 14, wherein the obtained fault codes are at least partially contained in telematics data sets, wherein the telematics data sets are received from the plurality of utility vehicle trailers.

17. The server as claimed in claim 16, wherein each fault code contained in the telematics data sets represents an undesired behavior of the respective utility vehicle trailer or one or more components of the respective utility vehicle trailer detected by a data processing unit of the respective utility vehicle trailer of the plurality of utility vehicle trailers, wherein the data processing unit of the respective utility vehicle trailer has detected the undesired behavior based on a respective first sensor data set of the respective utility vehicle trailer, wherein the respective first sensor data set comprises sensor data which were captured by vehicle sensors of the respective utility vehicle trailer.

18. The server as claimed in claim 14, wherein the at least one memory and the program instructions are furthermore configured, together with the at least one processor, to cause the server to perform the following alone or in cooperation with the one or more further servers:
holding, for each utility vehicle trailer of the plurality of utility vehicle trailers, a respective digital representation of the respective utility vehicle trailer;
receiving a second sensor data set at least for one utility vehicle trailer of the plurality of utility vehicle trailers, wherein the second sensor data set comprises sensor data which were captured by vehicle sensors of the utility vehicle trailer, and wherein the second sensor data set represents a second state of the utility vehicle trailer;
updating the digital representation of the utility vehicle trailer based on the second sensor data set in order to obtain an updated digital representation of the utility vehicle trailer in the second state;
detecting, based on the updated digital representation of the utility vehicle trailer, at least one of an unknown undesired behavior of the utility vehicle trailer or one or more components of the utility vehicle trailer;
in reaction to the detection of the unknown undesired behavior, assigning a fault code to the detected undesired behavior.

19. The server as claimed in claim 14, wherein the evaluation comprises at least one of a statistical evaluation of the obtained fault codes or the determination of statistical characteristic variables for the plurality of fault codes.

20. The server as claimed in claim 19, wherein the determination of statistical characteristic variables is repeated at specific time intervals, wherein with each repetition, in each case only the characteristic variables are determined for the fault codes which were obtained since the last repetition.

21. The server as claimed in claim 19, wherein the statistical characteristic variables are each determined for different groups of utility vehicle trailers of the plurality of utility vehicle trailers, wherein for each of the groups of utility vehicle trailers of the plurality of utility vehicle trailers, in each case only the characteristic variables are determined for the fault codes which were received for the utility vehicle trailers of these groups of utility vehicle trailers of the plurality of utility vehicle trailers.

22. The server as claimed in claim 19, wherein at least one of the following are obtained as the result of the evaluation:
the statistical characteristic variables; or
an indication of whether a statistical anomaly was detected.
